(19) United States
(12) Patent Application Publication
(10) Pub. No.: US 2022/0078769 A1
(43) Pub. Date: Mar. 10, 2022

(54) TERMINAL APPARATUS, BASE STATION APPARATUS, AND COMMUNICATION METHOD

(71) Applicants: Sharp Kabushiki Kaisha, Sakai City, Osaka (JP); FG Innovation Company Limited, Tuen Mun, New Territories (HK)

(72) Inventors: Huifa LIN, Sakai City (JP); Shoichi SUZUKI, Sakai City (JP); Daiichiro NAKASHIMA, Sakai City (JP); Toshizo NOGAMI, Sakai City (JP); Wataru OUCHI, Sakai City (JP); Tomoki YOSHIMURA, Sakai City (JP); Taewoo LEE, Sakai City (JP)

(21) Appl. No.: 17/423,127

(22) PCT Filed: Jan. 30, 2020
(86) PCT No.: PCT/JP2020/003287

§ 371 Date: Jul. 15, 2021

(30) Foreign Application Priority Data
Feb. 8, 2019 (JP) 2019-021631

(51) Int. Cl. H04W 72/04; H04L 1/18; H04L 1/16

(52) U.S. Cl. CPC H04W 72/042; H04L 1/1607; H04L 1/1812

(57) ABSTRACT

It is possible to efficiently perform uplink transmission. A terminal apparatus includes: a receiver configured to receive a PDCCH, and receive a PDSCH scheduled based at least on a DCI format included in the PDCCH; and a transmitter configured to report (transmit) HARQ-ACK information corresponding to the PDSCH. A slot for transmitting the HARQ-ACK information is indicated based at least on a combination of a value indicated by a PDSCH-to-HARQ feedback timing indicator field included in the DCI format and a prescribed element. The prescribed element at least includes some or all of an element 1, an element 2, an element 3, an element 4, an element 5, an element 6, an element 7, and an element 8.

### TECHNICAL FIELD

The present invention relates to a terminal apparatus, a base station apparatus, and a communication method. This application claims priority based on JP 2019-21631 filed on Feb. 8, 2019, the contents of which are incorporated herein by reference.

### BACKGROUND ART

In the 3^{rd} Generation Partnership Project (3GPP), a radio access method and a radio network for cellular mobile communications (hereinafter referred to as “Long Term Evolution (LTE)” or “Evolved Universal Terrestrial Radio Access (EUTRA)”) have been studied. In LTE, a base station apparatus is also referred to as an evolved NodeB (eNodeB), and a terminal apparatus is also referred to as User Equipment (UE). LTE is a cellular communication system in which multiple areas, each being covered by a base station apparatus, are deployed in a cell structure. A single base station apparatus may manage multiple serving cells.

3GPP has been studying a next generation standard (New Radio or NR) (NPL 1) to make a proposal for International Mobile Telecommunication (IMT)-2020, a standard for a next generation mobile communication system developed by the International Telecommunication Union (ITU). NR is required to satisfy requirements for three use cases including enhanced Mobile BroadBand (eMBB), massive Machine Type Communication (mMTC), and Ultra Reliable and Low Latency Communication (URLLC) in a single technology framework.

### CITATION LIST

### Non Patent Literature

NPL 1: “New SID proposal: Study on New Radio Access Technology”, RP-160671, NTT docomo, 3GPP TSG RAN Meeting #71, Goteborg, Sweden, 7-10 Mar. 2016.

### SUMMARY OF INVENTION

### Technical Problem

One aspect of the present invention provides a terminal apparatus that efficiently performs communication, a communication method used for the terminal apparatus, a base station apparatus that efficiently performs communication, and a communication method used for the base station apparatus.

### Solution to Problem

(1) The first aspect of the present invention is a terminal apparatus. The terminal apparatus includes: a receiver configured to receive a PDCCH, and receive a PDSCH scheduled based at least on a DCI format included in the PDCCH; and a transmitter configured to report (transmit) HARQ-ACK information corresponding to the PDSCH. A slot for transmitting the HARQ-ACK information is indicated based at least on a combination of a value indicated by a PDSCH-to-HARQ feedback timing indicator field included in the DCI format and a prescribed element. The prescribed element at least includes some or all of an element 1, an element 2, an element 3, an element 4, an element 5, an element 6, an element 7, and an element 8. The element 1 is a CCE index of the PDCCH. The element 2 is an index of a control resource set of the PDCCH. The element 3 is an index of a search space set of the PDCCH. The element 4 is a HARQ process identifier of the PDSCH. The element 5 is a slot index of the PDSCH. The element 6 is a value indicated by a PUCCH resource indicator field included in the DCI format. The element 7 is a value indicated by a Slot Format Indicator (SFI) field included in a second DCI format. The element 8 is an index of a resource block provided for the PDSCH.

(2) The second aspect of the present invention is the terminal apparatus. A higher layer parameter dl-DataToUL-ACK includes a list of timings of transmission of the HARQ-ACK information corresponding to the PDSCH. An index of the higher layer parameter dl-DataToUL-ACK indicating the slot for transmitting the HARQ-ACK information is indicated based at least on a combination of a value indicated by the PDSCH-to-HARQ feedback timing indicator field and the prescribed element.

(3) The third aspect of the present invention is a base station apparatus. The base station apparatus includes: a transmitter configured to transmit a PDCCH, and transmit a PDSCH scheduled based at least on a DCI format included in the PDCCH; and a receiver configured to receive HARQ-ACK information corresponding to the PDSCH. A slot in which a terminal apparatus receiving the PDSCH transmits the HARQ-ACK information is indicated based at least on a combination of a value indicated by a PDSCH-to-HARQ feedback timing indicator field included in the DCI format and a prescribed element. The prescribed element at least includes some or all of an element 1, an element 2, an element 3, an element 4, an element 5, an element 6, an element 7, and an element 8. The element 1 is a CCE index of the PDCCH. The element 2 is an index of a control resource set of the PDCCH. The element 3 is an index of a search space set of the PDCCH. The element 4 is a HARQ process identifier of the PDSCH. The element 5 is a slot index of the PDSCH. The element 6 is a value indicated by a PUCCH resource indicator field included in the DCI format. The element 7 is a value indicated by a Slot Format Indicator (SFI) field included in a second DCI format. The element 8 is an index of a resource block provided for the PDSCH.

(4) The fourth aspect of the present invention is a communication method used for a terminal apparatus. The communication method includes: receiving a PDCCH, and receiving a PDSCH scheduled based at least on a DCI format included in the PDCCH; and reporting (transmitting) HARQ-ACK information corresponding to the PDSCH. A slot for transmitting the HARQ-ACK information is indicated based at least on a combination of a value indicated by a PDSCH-to-HARQ feedback timing indicator field included in the DCI format and a prescribed element. The prescribed element at least includes some or all of an element 1, an element 2, an element 3, an element 4, an element 5, an element 6, an element 7, and an element 8. The element 1 is a CCE index of the PDCCH. The element 2 is an index of a control resource set of the PDCCH. The element 3 is an index of a search space set of the PDCCH. The element 4 is a HARQ process identifier of the PDSCH. The element 5 is a slot index of the PDSCH. The element 6 is a value indicated by a PUCCH resource indicator field included in the DCI format. The element 7 is a value indicated by a Slot Format Indicator (SFI) field included in a second DCI format. The element 8 is an index of a resource block provided for the PDSCH.

(5) The fifth aspect of the present invention is a communication method used for a base station apparatus. The communication method includes: transmitting a PDCCH, and transmitting a PDSCH scheduled based at least on a DCI format included in the PDCCH; and receiving HARQ-ACK information corresponding to the PDSCH. A slot in which a terminal apparatus receiving the PDSCH transmits the HARQ-ACK information is indicated based at least on a combination of a value indicated by a PDSCH-to-HARQ feedback timing indicator field included in the DCI format and a prescribed element. The prescribed element at least includes some or all of an element 1, an element 2, an element 3, an element 4, an element 5, an element 6, an element 7, and an element 8. The element 1 is a CCE index of the PDCCH. The element 2 is an index of a control resource set of the PDCCH. The element 3 is an index of a search space set of the PDCCH. The element 4 is a HARQ process identifier of the PDSCH. The element 5 is a slot index of the PDSCH. The element 6 is a value indicated by a PUCCH resource indicator field included in the DCI format. The element 7 is a value indicated by a Slot Format Indicator (SFI) field included in a second DCI format. The element 8 is an index of a resource block provided for the PDSCH.

### Advantageous Effects of Invention

According to one aspect of the present invention, the terminal apparatus can efficiently perform communication. In addition, the base station apparatus can efficiently perform communication.

### BRIEF DESCRIPTION OF DRAWINGS

FIG. 1 is a conceptual diagram of a radio communication system according to an aspect of the present embodiment.

FIG. 2 is an example illustrating a relationship of N^{slot}_{symb}, a subcarrier spacing configuration μ, a slot configuration, and a CP configuration according to an aspect of the present embodiment.

FIG. 3 is a schematic diagram illustrating an example of a resource grid in a subframe according to an aspect of the present embodiment.

FIG. 4 is a schematic block diagram illustrating structure of a terminal apparatus 1 according to an aspect of the present embodiment.

FIG. 5 is a schematic block diagram illustrating structure of a base station apparatus 3 according to an aspect of the present embodiment.

FIG. 6 is a diagram illustrating a method of calculating an index of dl-DataToUL-ACK in a case that a HARQ indicator field corresponds to one dl-DataToUL-ACK according to an aspect of the present embodiment.

### DESCRIPTION OF EMBODIMENTS

Embodiments of the present invention will be described below.

“A and/or B” may be a term including “A”, “B”, or “A and B”.

The fact that a parameter or information indicates one or multiple values may mean that the parameter or the information includes at least a parameter or information indicating the one or the multiple values. A higher layer parameter may be a single higher layer parameter. The higher layer parameter may be an Information Element (IE) including multiple parameters.

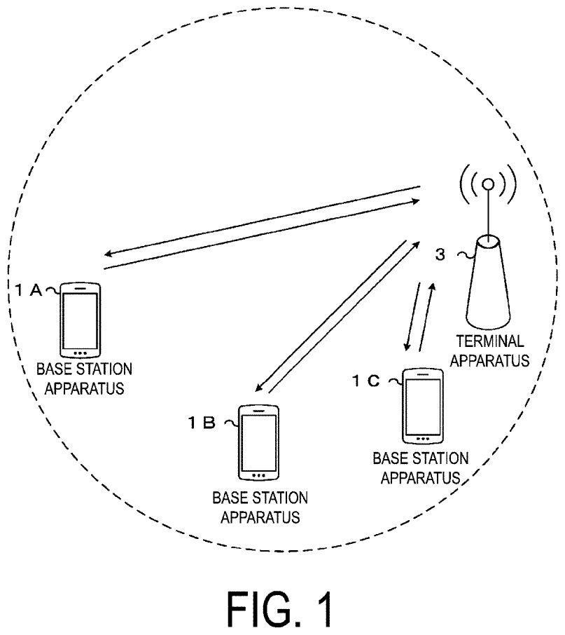

FIG. 1 is a conceptual diagram of a radio communication system according to an aspect of the present embodiment. In FIG. 1, the radio communication system includes terminal apparatuses 1A to 1C and a base station apparatus 3. Hereinafter, each of the terminal apparatuses 1A to 1C is also referred to as a terminal apparatus 1.

The base station apparatus 3 may include one of or both a Master Cell Group (MCG) and a Secondary Cell Group (SCG). The MCG is a group of serving cells including at least a Primary Cell (PCell). The SCG is a group of serving cells including at least a Primary Secondary Cell (PSCell). The PCell may be a serving cell provided based on an initial connection. The MCG may include one or multiple Secondary Cells (SCells). The SCG may include one or multiple SCells. A serving cell identity is a short identity for identifying the serving cell. The serving cell identity may be provided by a higher layer parameter.

Hereinafter, a frame structure will be described.

In the radio communication system according to an aspect of the present embodiment, at least Orthogonal Frequency Division Multiplex (OFDM) is used. The OFDM symbol is a unit of a time domain of the OFDM. The OFDM symbol includes at least one or multiple subcarriers. The OFDM symbol may be converted into a time-continuous signal in baseband signal generation.

A SubCarrier Spacing (SCS) may be provided by a subcarrier spacing Δf=2 μ·15 kHz. For example, a subcarrier spacing configuration μ may be configured to be any of 0, 1, 2, 3, 4, and/or 5. For a certain BandWidth Part (BWP), the subcarrier spacing configuration μ may be provided by a higher layer parameter.

In the radio communication system according to an aspect of the present embodiment, a time unit T_{c} is used for representing a length of the time domain. The time unit T_{c} may be provided as T_{c}=1/(Δfₘₐₓ·N_{f}). Δfₘₐₓ may be the maximum value of the subcarrier spacing supported by the radio communication system according to an aspect of the present embodiment. Δfₘₐₓ may satisfy Δfₘₐₓ=480 kHz. N_{f} may satisfy N_{f}=4096. A constant κ satisfies κ=Δfₘₐₓ·N_{f}/(Δf_{ref}N_{f, ref})=64. Δf_{ref} may be 15 kHz. N_{f, ref} may be 2048.

The constant κ may be a value indicating a relationship between a reference subcarrier spacing and T_{c}. The constant κ may be used for a length of a subframe. The number of slots included in the subframe may be provided based at least on the constant κ. Δf_{ref} is the reference subcarrier spacing, and N_{f, ref} is a value corresponding to the reference subcarrier spacing.

Downlink transmission and/or uplink transmission includes frames of 10 ms. A frame includes 10 subframes. A length of a subframe is 1 ms. The length of the frame may be provided regardless of the subcarrier spacing Δf. In other words, the frame configuration may be provided regardless of μ. The length of the subframe may be provided regardless of the subcarrier spacing Δf. In other words, the configuration of the subframe may be provided regardless of ∥.

For a certain subcarrier spacing configuration μ, the number and indexes of slots included in a subframe may be provided. For example, a first slot number n^{μ}ₛ may be provided in ascending order ranging from 0 to N^{subframe, μ}ₛₗₒₜ−1 within a subframe. For the subcarrier spacing configuration μ, the number and indexes of slots included in a frame may be provided. For example, a second slot number n^{μ}_{s, f} may be provided in ascending order ranging from 0 to N^{frame, μ}ₛₗₒₜ−1 within a frame. N^{slot}_{symb} continuous OFDM symbols may be included in one slot. N^{slot}_{symb} may be provided based at least on a part or an entirety of a slot configuration and/or a Cyclic Prefix (CP) configuration. The slot configuration may be provided at least by a higher layer parameter tdd-UL-DL-ConfigurationCommon. The CP configuration may be provided based at least on a higher layer parameter. The CP configuration may be provided based at least on dedicated RRC signaling. Each of the first slot number and the second slot number is also referred to as slot number (slot index).

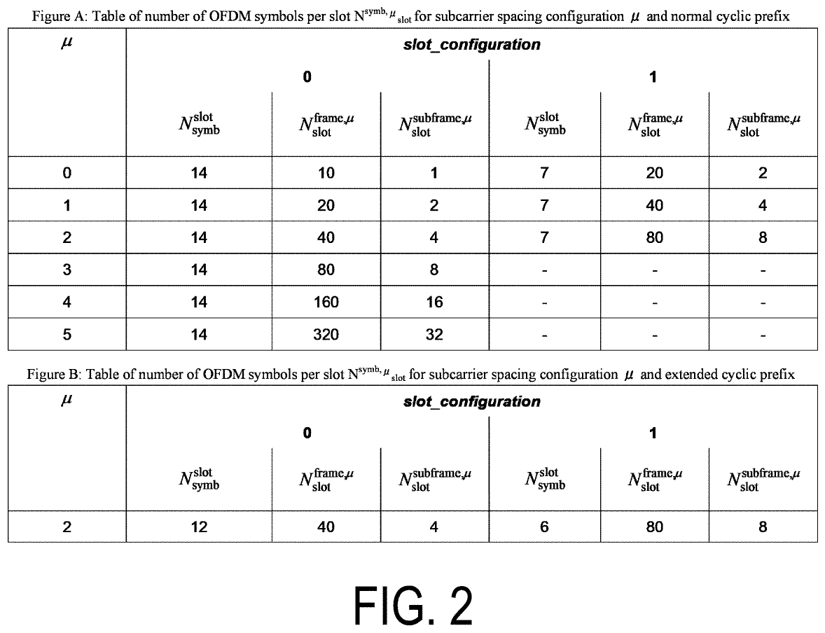

FIG. 2 is an example illustrating a relationship of N^{slot}_{symb}, a subcarrier spacing configuration μ, a slot configuration, and a CP configuration according to an aspect of the present embodiment. In FIG. 2A, in a case that the slot configuration is zero, the subcarrier spacing configuration μ is two, and the CP configuration is a normal cyclic prefix (normal CP), N^{slot}_{symb}=14, N^{frame, μ}ₛₗₒₜ=40, and N^{subframe, μ}ₛₗₒₜ=4. In addition, in FIG. 2B, in a case that the slot configuration is zero, the subcarrier spacing configuration μ is two, and the CP configuration is an extended cyclic prefix (extended CP), N^{slot}_{symb}=12, N^{frame, μ}ₛₗₒₜ=40, and N^{subframe, μ}ₛₗₒₜ=4. The value of N^{slot}_{symb} in the slot configuration 0 may correspond to twice the value of N^{slot}_{symb} in the slot configuration 1.

Physical resources will be described below.

An antenna port is defined in such a manner that a channel through which a symbol is transmitted at one antenna port can be estimated from a channel through which another symbol is transmitted at the same antenna port. In a case that a large scale property of a channel through which a symbol is transmitted at one antenna port can be estimated from a channel through which a symbol is transmitted at another antenna port, the two antenna ports are referred to as Quasi Co-Located (QCL). The large scale properties may include at least a long term performance of a channel The large scale properties may include at least some or all of delay spread, Doppler spread, Doppler shift, an average gain, an average delay, and beam parameters (spatial Rx parameters). The fact that a first antenna port and a second antenna port are QCL with respect to a beam parameter may mean that a reception beam assumed by the reception side for the first antenna port is the same as a reception beam assumed by the reception side for the second antenna port. The fact that the first antenna port and the second antenna port are QCL with respect to a beam parameter may mean that a transmission beam assumed by the reception side for the first antenna port is the same as a transmission beam assumed by the reception side for the second antenna port. In a case that a large scale property of a channel through which a symbol is transmitted at one antenna port can be estimated from a channel through which a symbol is transmitted at another antenna port, the two antenna ports may be assumed to be QCL in the terminal apparatus 1. The fact that the two antenna ports are QCL may mean that the two antenna ports are assumed to be QCL.

For each set of a subcarrier spacing configuration and a carrier, a resource grid including N^{μ}_{PB, x}N^{RB}_{sc} subcarriers and N^{(μ)}_{symb}N^{subframe, μ}_{symb} OFDM symbols is provided. N^{μ}_{PB, x} may indicate the number of resource blocks provided for the subcarrier spacing configuration μ for a carrier x. N^{μ}_{PB, x} may indicate the maximum number of resource blocks provided for the subcarrier spacing configuration μ for the carrier x. The carrier x indicates either a downlink carrier or an uplink carrier. In other words, x is “DL” or “UL”. N^{μ}_{RB} is a name including N^{μ}_{RB, DL} and/or N^{μ}_{RB, UL}. N^{RB}_{sc} may indicate the number of subcarriers included in one resource block. At least one resource grid may be provided for each antenna port p and/or for each subcarrier spacing configuration μ and/or for each Transmission direction configuration. The transmission direction includes at least DownLink (DL) and UpLink (UL). Hereinafter, a set of parameters including at least some or all of the antenna port p, the subcarrier spacing configuration μ, and the transmission direction configuration is also referred to as a first radio parameter set. In other words, one resource grid may be provided for each first radio parameter set.

A carrier included in a serving cell in downlink is referred to as a downlink carrier (or a downlink component carrier). A carrier included in a serving cell in uplink is referred to as an uplink carrier (uplink component carrier). A downlink component carrier and an uplink component carrier are collectively referred to as a component carrier (or a carrier).

Each element in the resource grid provided for each first radio parameter set is referred to as a resource element. The resource element is identified by an index k_{sc} of the frequency domain and an index l_{sym} of the time domain. The resource element is identified by an index k_{sc} of the frequency domain and an index l_{sym} of the time domain for a certain first radio parameter set. The resource element to be identified by the index k_{sc} of the frequency domain and the index l_{sym} of the time domain is also referred to as a resource element (k_{sc}, l_{sym}). The index k_{sc} of the frequency domain indicates any value from 0 to N^{μ}_{RB}N^{RB}_{sc}−1. N^{μ}_{RB} may be the number of resource blocks provided for the subcarrier spacing configuration μ. N^{RB}_{sc} is the number of subcarriers included in a resource block, and N^{RB}_{sc}=12. The index k_{sc} of the frequency domain may correspond to a subcarrier index k_{sc}. The index l_{sym} of the time domain may correspond to an OFDM symbol index l_{sym}.

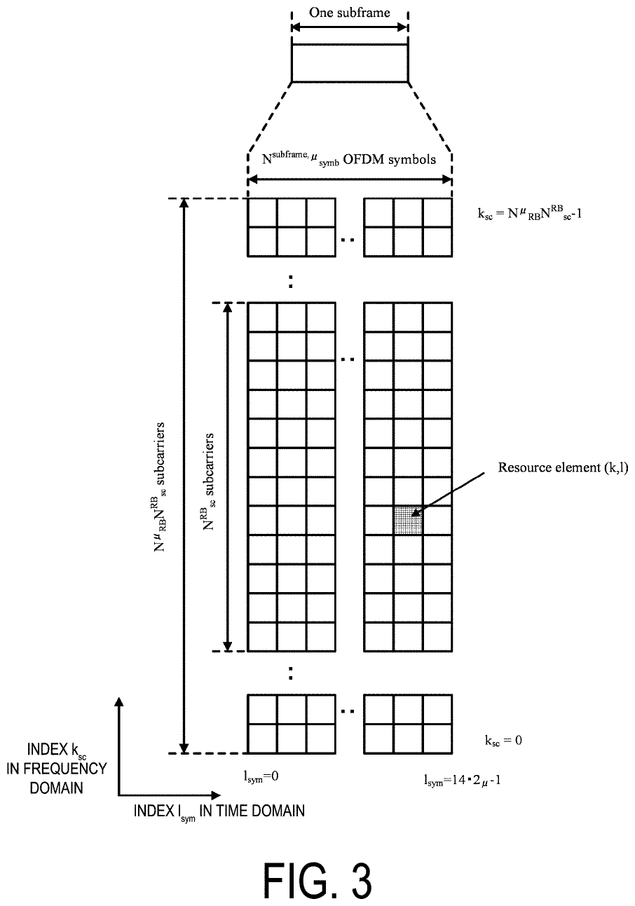

FIG. 3 is a schematic diagram illustrating an example of a resource grid in a subframe according to an aspect of the present embodiment. In the resource grid in FIG. 3, the horizontal axis is the index l_{sym} of the time domain, and the vertical axis is the index k_{sc} of the frequency domain. In one subframe, the frequency domain of the resource grid includes N^{μ}_{RB}N^{RB}_{sc} subcarriers. In one subframe, the time domain of the resource grid may include 14·2 μ OFDM symbols. One resource block includes N^{RB}_{sc} subcarriers. The time domain of the resource block may correspond to one OFDM symbol. The time domain of the resource block may correspond to 14 OFDM symbols. The time domain of the resource block may correspond to one or multiple slots. The time domain of the resource block may correspond to one subframe.

The terminal apparatus 1 may receive an indication of transmission and/or reception using only a subset of resource grids. The subset of resource grids is also referred to as a BWP, and the BWP may be provided based at least on a part or an entirety of the higher layer parameter and/or DCI. The BWP is also referred to as a bandwidth part (BP). In other words, the terminal apparatus 1 may not receive an indication of transmission and/or reception using all sets of resource grids. In other words, the terminal apparatus 1 may receive an indication of transmission and/or reception using some frequency resources within the resource grid. One BWP may include multiple resource blocks in the frequency domain. One BWP may include multiple resource blocks that are continuous in the frequency domain. A BWP configured for a downlink carrier is also referred to as a downlink BWP. A BWP configured for an uplink carrier is also referred to as an uplink BWP.

One or multiple downlink BWPs may be configured for the terminal apparatus 1. The terminal apparatus 1 may attempt to receive a physical channel (for example, a PDCCH, a PDSCH, and/or an SS/PBCH) in one downlink BWP out of the one or multiple downlink BWPs. The one downlink BWP is also referred to as an active downlink BWP.

One or multiple uplink BWPs may be configured for the terminal apparatus 1. The terminal apparatus 1 may attempt to transmit a physical channel (for example, a PUCCH, a PUSCH, and/or a PRACH) in one uplink BWP out of the one or multiple uplink BWPs. The one uplink BWP is also referred to as an active uplink BWP.

A set of downlink BWPs may be configured for each serving cell. The set of downlink BWPs may include one or multiple downlink BWPs. A set of uplink BWPs may be configured for each serving cell. The set of uplink BWPs may include one or multiple uplink BWPs.

A higher layer parameter is a parameter included in a higher layer signaling. The higher layer signaling may be Radio Resource Control (RRC) signaling or a Medium Access Control Control Element (MAC CE). Here, the higher layer signaling may be an RRC layer signal or an MAC layer signal.

The higher layer signaling may be common RRC signaling. The common RRC signaling may include at least some or all of the following features C1 to C3.

Feature C1) to be mapped to a BCCH logical channel or a CCCH logical channel,

Feature C2) to at least include a radioResourceConfigCommon information element, or

Feature C3) to be mapped to a PBCH.

The radioResourceConfigCommon information element may include information indicating a configuration commonly used in a serving cell. The configuration commonly used in a serving cell may include at least a PRACH configuration. The PRACH configuration may indicate at least one or multiple random access preamble indexes. The PRACH configuration may indicate at least a time/frequency resource of the PRACH.

The higher layer signaling may be dedicated RRC signaling. The dedicated RRC signaling may include at least some or all of the following features D1 and D2.

Feature D1) to be mapped to a DCCH logical channel, or

Feature D2) to include at least a radioResourceConfigDedicated information element.

The radioResourceConfigDedicated information element may include at least information indicating a configuration specific to the terminal apparatus 1. The radioResourceConfigDedicated information element may include at least information indicating a BWP configuration. The BWP configuration may indicate at least a frequency resource of the BWP.

For example, a MIB, first system information, and second system information may be included in the common RRC signaling. In addition, a higher layer message that is mapped to the DCCH logical channel and includes at least radioResourceConfigCommon may be included in the common RRC signaling. In addition, a higher layer message that is mapped to the DCCH logical channel and does not include the radioResourceConfigCommon information element may be included in the dedicated RRC signaling. In addition, a higher layer message that is mapped to the DCCH logical channel and includes at least the radioResourceConfigDedicated information element may be included in the dedicated RRC signaling.

The first system information may indicate at least a time index of a Synchronization Signal (SS) block. The SS block is also referred to as an SS/PBCH block. The SS/PBCH block is also referred to as an SS/PBCH. The first system information may include at least information related to a PRACH resource. The first system information may include at least information related to a configuration of initial connection. The second system information may be system information other than the first system information.

The radioResourceConfigDedicated information element may include at least information related to a PRACH resource. The radioResourceConfigDedicated information element may include at least information related to the configuration of initial connection.

A physical channel and physical signal according to various aspects of the present embodiment will be described below.

An uplink physical channel may correspond to a set of resource elements that convey information generated in a higher layer. The uplink physical channel is a physical channel used in uplink carrier. In the radio communication system according to an aspect of the present embodiment, at least some or all of the uplink physical channels described below are used.

Physical Uplink Control CHannel (PUCCH)

Physical Uplink Shared CHannel (PUSCH)

Physical Random Access CHannel (PRACH)

The PUCCH may be used to transmit Uplink Control Information (UCI). The uplink control information includes some or all of Channel State Information (CSI), a Scheduling Request (SR), and a Hybrid Automatic Repeat request ACKnowledgement (HARQ-ACK) corresponding to a transport block (TB, a Medium Access Control Protocol Data Unit (MAC PDU), Downlink-Shared Channel (DL-SCH), and/or a Physical Downlink Shared Channel (PDSCH)).

The HARQ-ACK may include at least a HARQ-ACK bit corresponding at least to one transport block. The HARQ-ACK bit may indicate an acknowledgement (ACK) or a negative-acknowledgement (NACK) corresponding to one or multiple transport blocks. The HARQ-ACK may include at least a HARQ-ACK codebook including one or multiple HARQ-ACK bits. The fact that the HARQ-ACK bit corresponds to one or multiple transport blocks may mean that the HARQ-ACK bit corresponds to a PDSCH including the one or the multiple transport blocks. The HARQ-ACK bit may indicate an ACK or NACK corresponding to one Code Block Group (CBG) included in the transport block.

The Scheduling Request (SR) may be used at least for requesting a resource of a PUSCH for initial transmission. A scheduling request bit may be used to indicate either a positive SR or a negative SR. The scheduling request bit indicating the positive SR is also referred to as “the positive SR being transmitted”. The positive SR may indicate that a resource of the PUSCH for initial transmission is requested by the terminal apparatus 1. The positive SR may indicate that a scheduling request is triggered by the higher layer. The positive SR may be transmitted in a case that the higher layer indicates transmission of the scheduling request. The scheduling request bit indicating the negative SR is also referred to as “the negative SR being transmitted”. The negative SR may indicate that the resource of the PUSCH for initial transmission is not requested by the terminal apparatus 1. The negative SR may indicate that the scheduling request is not triggered by the higher layer. The negative SR may be transmitted in a case that transmission of a scheduling request is not indicated by the higher layer.

Channel state information may include at least some or all of a Channel Quality Indicator (CQI), a Precoder Matrix Indicator (PMI), and a Rank Indicator (RI). The CQI is an indicator related to channel quality (for example, propagation intensity), and the PMI is an indicator that indicates a precoder. The RI is an indicator indicating a transmission rank (or the number of transmission layers).

The PUCCH supports PUCCH formats (PUCCH formats 0 to 4). The PUCCH formats may be mapped to the PUCCH and may then be transmitted. The PUCCH format may be transmitted through the PUCCH. The fact that the PUCCH format is transmitted may mean that the PUCCH is transmitted.

The PUSCH may be used at least to transmit a transport block ((TB), the MAC PDU, a UL-SCH, and/or the PUSCH). The PUSCH may be used to transmit at least some or all of the transport block, the HARQ-ACK, the channel state information, and the scheduling request. The PUSCH is used at least to transmit a random access message 3.

The PRACH is used at least to transmit a random access preamble (random access message 1). The PRACH may be used at least to indicate some or all of an initial connection establishment procedure, a handover procedure, a connection re-establishment procedure, synchronization for PUSCH transmission (timing adjustment), and a resource request for the PUSCH. The random access preamble may be used to notify the base station apparatus 3 of an index (random access preamble index) provided by a higher layer of the terminal apparatus 1.

In FIG. 1, the following uplink physical signals are used for uplink radio communication. The uplink physical signals may not be used to transmit information output from a higher layer, but is used by a physical layer.

UpLink Demodulation Reference Signal (UL DMRS)

Sounding Reference Signal (SRS)

UpLink Phase Tracking Reference Signal (UL PTRS)

The UL DMRS is associated with transmission of the PUSCH and/or the PUCCH. The UL DMRS is multiplexed with the PUSCH or the PUCCH. The base station apparatus 3 may use the UL DMRS in order to perform channel compensation of the PUSCH or the PUCCH. Hereinafter, transmission of both a PUSCH and a UL DMRS associated with the PUSCH will be simply referred to as transmission of a PUSCH. Hereinafter, transmission of both a PUCCH and a UL DMRS associated with the PUCCH will be simply referred to as transmission of a PUCCH. The UL DMRS associated with the PUSCH is also referred to as a UL DMRS for a PUSCH. The UL DMRS associated with the PUCCH is also referred to as a UL DMRS for a PUCCH.

The SRS may not be associated with transmission of the PUSCH or the PUCCH. The base station apparatus 3 may use the SRS for measuring a channel state. The SRS may be transmitted at the end of a subframe in an uplink slot or at a prescribed number of OFDM symbols from the end.

The UL PTRS may be a reference signal that is used at least for phase tracking. The UL PTRS may be associated with a UL DMRS group including at least an antenna port used for one or multiple UL DMRSs. The fact that the UL PTRS associates with the UL DMRS group may mean that at least the antenna port for the UL PTRS and some or all of the antenna ports included in the UL DMRS group are QCL. The UL DMRS group may be identified based at least on the antenna port of the lowest index for the UL DMRS included in the UL DMRS group. The UL PTRS may be mapped to the antenna port of the smallest index from among one or more antenna ports to which one codeword is mapped. The UL PTRS may be mapped to a first layer in a case that one codeword is mapped at least to the first layer and a second layer. The UL PTRS may not be mapped to the second layer. The index of the antenna port to which the UL PTRS is mapped may be provided based at least on the downlink control information.

In FIG. 1, the following downlink physical channels are used for downlink radio communication from the base station apparatus 3 to the terminal apparatus 1. The downlink physical channels are used by the physical layer for transmission of information output from a higher layer.

Physical Broadcast Channel (PBCH)

Physical Downlink Control Channel (PDCCH)

Physical Downlink Shared Channel (PDSCH)

The PBCH is used at least to transmit a Master Information Block ((MIB), and/or a Broadcast Channel(BCH)). The PBCH may be transmitted based on a prescribed transmission interval. The PBCH may be transmitted at an interval of 80 ms. The PBCH may be transmitted at an interval of 160 ms. Contents of information included in the PBCH may be updated at every 80 ms. A part or an entirety of the information included in the PBCH may be updated at every 160 ms. The PBCH may include 288 subcarriers. The PBCH may include two, three, or four OFDM symbols. The MIB may include information associated with an identity (index) of a synchronization signal. The MIB may include information indicating at least some of a slot number, a subframe number, and/or a radio frame number in which a PBCH is transmitted.

The PDCCH is used at least to transmit Downlink Control Information (DCI). The PDCCH may be transmitted with at least the downlink control information included therein. The PDCCH may include the downlink control information. The downlink control information is also referred to as a DCI format. The downlink control information may include at least either a downlink grant or an uplink grant. The DCI format used for scheduling the PDSCH is also referred to as a downlink DCI format. The DCI format used for scheduling the PUSCH is also referred to as an uplink DCI format. The downlink grant is also referred to as downlink assignment or downlink allocation. The uplink DCI format includes at least one of or both DCI format 0_0 and DCI format 0_1.

DCI format 0_0 includes at least some or all of 1A to 1F.

1A) DCI format specification field (Identifier for DCI formats field)

1B) Frequency domain resource assignment field

1C) Time domain resource assignment field

1D) Frequency hopping flag field

1E) Modulation and Coding Scheme field (MCS field)

1F) First CSI request field

The DCI format specification field may be used at least to indicate which of one or multiple DCI formats the DCI format including the DCI format specification field corresponds to. The one or multiple DCI formats may be provided based at least on some or all of DCI format 1_0, DCI format 1_1, DCI format 0_0, and/or DCI format 0_1.

The frequency domain resource assignment field may be used at least to indicate assignment of a frequency resource for the PUSCH scheduled by the DCI format including the frequency domain resource assignment field. The frequency domain resource assignment field is also referred to as Frequency Domain Resource Allocation (FDRA) field.

The time domain resource assignment field may be used at least to indicate assignment of a time resource for the PUSCH scheduled by the DCI format including the time domain resource assignment field.

The frequency hopping flag field may be used at least to indicate whether frequency hopping is to be applied to the PUSCH scheduled by the DCI format including the frequency hopping flag field.

The MCS field may be used at least to indicate some or all of a modulation scheme for the PUSCH scheduled by the DCI format including the MCS field and/or a target coding rate. The target coding rate may be a target coding rate for a transport block of the PUSCH. The size of the transport block (Transport Block Size (TBS)) may be provided based at least on the target coding rate.

The first CSI request field is used at least to indicate a report of the CSI. The size of the first CSI request field may be a prescribed value. The size of the first CSI request field may be zero, may be one, may be two, or may be three.

DCI format 0_1 includes at least some or all of 2A to 2G.

2A) DCI format specification field

2B) Frequency domain resource assignment field

2C) Time domain resource assignment field

2D) Frequency hopping flag field

2E) MCS field

2F) Second CSI request field

2G) BWP field

The BWP field may be used to indicate the uplink BWP to which the PUSCH scheduled by DCI format 0_1 is mapped.

The second CSI request field is used at least to indicate a report of the CSI. The size of the second CSI request field may be provided based at least on a parameter ReportTriggerSize of the higher layer.

The downlink DCI format includes at least one of or both DCI format 1_0 and DCI format 1_1.

DCI format 1_0 includes at least some or all of 3A to 3H.

3A) DCI format specification field (Identifier for DCI formats field)

3B) Frequency domain resource assignment field

3C) Time domain resource assignment field

3D) Frequency hopping flag field

3E) Modulation and Coding Scheme field (MCS field)

3F) First CSI request field

3G) PDSCH-to-HARQ feedback timing indicator field

3H) PUCCH resource indicator field

The timing indicator field from the PDSCH to the HARQ feedback may be a field indicating a timing K1. In a case that the index of the slot including the last OFDM symbol of the PDSCH is a slot n, the index of the slot including the PUCCH or the PUSCH including at least HARQ-ACK corresponding to the transport block included in the PDSCH may be n+K1. In a case that the index of the slot including the last OFDM symbol of the PDSCH is a slot n, the index of the slot including the OFDM symbol at the head of the PUCCH or the OFDM symbol at the head of the PUSCH including at least HARQ-ACK corresponding to the transport block included in the PDSCH may be n+K1.

The PDSCH-to-HARQ feedback timing indicator field (PDSCH-to-HARQ_feedback timing indicator field) may be hereinafter referred to as a HARQ indicator field.

The PUCCH resource indicator field may be a field indicating indexes of one or multiple PUCCH resources included in the PUCCH resource set.

DCI format 1_1 includes at least some or all of 4A to 4J.

4A) DCI format specification field (Identifier for DCI formats field)

4B) Frequency domain resource assignment field

4C) Time domain resource assignment field

4D) Frequency hopping flag field

4E) Modulation and Coding Scheme field (MCS field)

4F) First CSI request field

4G) PDSCH-to-HARQ feedback timing indicator field

4H) PUCCH resource indicator field

4J) BWP field

The BWP field may be used to indicate the downlink BWP to which the PDSCH scheduled by DCI format 1_1 is mapped.

DCI format 2_0 may at least include one or multiple Slot Format Indicators (SFIs).

In various aspects of the present embodiment, the number of resource blocks indicates the number of resource blocks in the frequency domain unless otherwise specified.

The downlink grant is used at least for scheduling a single PDSCH in a single serving cell.

The uplink grant is used at least for scheduling a single PUSCH in a single serving cell.

A single physical channel may be mapped to a single serving cell. A single physical channel may be mapped to a single BWP configured to a single carrier included in a single serving cell.

In the terminal apparatus 1, one or multiple COntrol REsource SETs (CORESETs) may be configured. The terminal apparatus 1 monitors the PDCCH in the one or multiple control resource sets. Here, monitoring of the PDCCH in the one or multiple control resource sets may include monitoring of one or multiple PDCCHs corresponding to the one or multiple control resource sets, respectively. Note that the PDCCH may include a set of one or multiple PDCCH candidates and/or one or multiple PDCCH candidates. Also, monitoring of the PDCCH may include monitoring and detecting the PDCCH and/or a DCI format transmitted via the PDCCH.

The control resource set may indicate a time-frequency domain to which one or multiple PDCCHs can be mapped. The control resource set may be an area in which the terminal apparatus 1 monitors the PDCCH. The control resource set may include continuous resources (Localized resources). The control resource set may include non-continuous resources (distributed resources).

In the frequency domain, the unit of mapping of the control resource set may be a resource block. In the frequency domain, for example, the unit of mapping of the control resource set may be six resource blocks. In the time domain, the unit of mapping of the control resource set may be an OFDM symbol. In the time domain, for example, the unit of mapping of the control resource set may be one OFDM symbol.

Mapping of the control resource set to the resource block may be provided based at least on the higher layer parameter. The higher layer parameter may include a bitmap for a Resource Block Group (RBG). The resource block group may be provided by six continuous resource blocks.

The number of OFDM symbols included in the control resource set may be provided based at least on the higher layer parameter.

A certain control resource set may be a Common control resource set. The common control resource set may be a control resource set configured commonly to multiple terminal apparatuses 1. The common control resource set may be provided at least based on some or all of the MIB, the first system information, the second system information, the common RRC signaling, and a cell ID. For example, the time resource and/or the frequency resource of the control resource set configured to monitor the PDCCH to be used for scheduling the first system information may be provided based at least on the MIB.

The control resource set configured by the MIB is also referred to as CORESET#0. CORESET#0 may be a control resource set of index#0.

A certain control resource set may be a Dedicated control resource set. The dedicated control resource set may be a control resource set configured to be used exclusively for the terminal apparatus 1. The dedicated control resource set may be provided based at least on some or all of the dedicated RRC signaling and values of C-RNTI. Multiple control resource sets may be configured for the terminal apparatus 1, and an index (control resource set index) may be provided for each of the control resource sets. One or more control channel elements (CCEs) may be configured in the control resource set, and an index (CCE index) may be provided for each of the CCEs.

The set of PDCCH candidates monitored by the terminal apparatus 1 may be defined in terms of a search space. In other words, the set of PDCCH candidates monitored by the terminal apparatus 1 may be provided by the search space.

The search space may include one or multiple PDCCH candidates at one or multiple Aggregation levels. The aggregation level of the PDCCH candidates may indicate the number of CCEs included in the PDCCH. The PDDCH candidate may be mapped to one or multiple CCEs.

The terminal apparatus 1 may monitor at least one or multiple search spaces in a slot in which Discontinuous reception (DRX) is not configured. The DRX may be provided based at least on a higher layer parameter. The terminal apparatus 1 may monitor at least one or multiple Search space sets in the slot in which the DRX is not configured. Multiple search space sets may be configured for the terminal apparatus 1. An index (search space set index) may be provided for each of the search space sets.

The search space set may include at least one or multiple search spaces. An index (search space index) may be provided for each of the search spaces.

Each search space set may be associated at least with one control resource set. Each search space set may be included in one control resource set. An index of the control resource set associated with the search space set may be provided to each search space set.

A physical resource of the search space includes a Control Channel Element (CCE). The CCE includes a prescribed number of Resource Element Groups (REGs). For example, the CCE may include six REGs. The REG may include one Physical Resource Block (PRB) during one OFDM symbol. In other words, the REG may include 12 Resource Elements (REs). The PRB is also simply referred to as a Resource Block (RB).

The PDSCH is used at least to transmit the transport block. The PDSCH may be used at least to transmit a random access message 2 (random access response). The PDSCH may be used at least to transmit system information including parameters used for initial access.

In FIG. 1, the following downlink physical signals are used for the downlink radio communication. The downlink physical signals may not be used for transmitting information output from a higher layer, but is used by the physical layer.

Synchronization Signal (SS)

DownLink DeModulation Reference Signal (DL DMRS)

Channel State Information-Reference Signal (CSI-RS)

DownLink Phase Tracking Reference Signal (DL PTRS)

The synchronization signal is used for the terminal apparatus 1 to establish synchronization in a frequency domain and/or a time domain of the downlink. The synchronization signal includes a Primary Synchronization Signal (PSS) and a Secondary Synchronization Signal (SSS).

An SS block (SS/PBCH block) includes at least some or all of the PSS, the SSS, and the PBCH.

The DL DMRS is associated with transmission of the PBCH, PDCCH and/or PDSCH. The DL DMRS is multiplexed to the PBCH, the PDCCH and/or the PDSCH. The terminal apparatus 1 may use the DL DMRS corresponding to the PBCH, the PDCCH, or the PDSCH to perform channel compensation of the PBCH, the PDCCH, or the PDSCH.

The CSI-RS may be a signal used at least to calculate channel state information. A pattern of the CSI-RS assumed by the terminal apparatus may be provided at least by a higher layer parameter.

The PTRS may be a signal used at least to compensate for phase noise. A pattern of the PTRS assumed by the terminal apparatus may be provided based at least on a higher layer parameter and/or the DCI.

The DL PTRS may be associated with a DL DMRS group that includes at least an antenna port used for one or multiple DL DMRSs.

The downlink physical channel and the downlink physical signal are also collectively referred to as the downlink signal. The uplink physical channel and the uplink physical signal are also collectively referred to as the uplink signal. The downlink signal and the uplink signal are also collectively referred to as the physical signal. The downlink signal and the uplink signal are also collectively referred to as the signal. The downlink physical channel and the uplink physical channel are collectively referred to as the physical channel The downlink physical signal and the uplink physical signal are collectively referred to as the physical signal.

A Broadcast CHannel (BCH), an Uplink-Shared CHannel (UL-SCH), and a Downlink-shared CHannel (DL-SCH) are transport channels. A channel used in a Medium Access Control (MAC) layer is referred to as a transport channel A unit of the transport channel used in the MAC layer is also referred to as a transport block (TB) or an MAC PDU. Control of the Hybrid Automatic Repeat reQuest (HARQ) is performed for each transport block in the MAC layer. The transport block is a unit of data that the MAC layer delivers to the physical layer. In the physical layer, the transport block is mapped to a codeword, and modulation processing is performed for each codeword.

The base station apparatus 3 and the terminal apparatus 1 exchange (transmit and/or receive) higher layer signals in the higher layer. For example, the base station apparatus 3 and the terminal apparatus 1 may transmit and/or receive, in a Radio Resource Control (RRC) layer, RRC signaling (a Radio Resource Control (RRC) message and/or Radio Resource Control (RRC) information). Also, the base station apparatus 3 and the terminal apparatus 1 may transmit and/or receive, in the MAC layer, a MAC Control Element (CE). Here, the RRC signaling and/or the MAC CE is also referred to as the higher layer signaling.

The PUSCH and the PDSCH may be used at least to transmit the RRC signaling and/or the MAC CE. Here, the RRC signaling transmitted from the base station apparatus 3 through the PDSCH may be signaling common to multiple terminal apparatuses 1 in a serving cell. The signaling common to the multiple terminal apparatuses 1 in the serving cell is also referred to as common RRC signaling. The RRC signaling transmitted from the base station apparatus 3 through the PDSCH may be signaling dedicated to a certain terminal apparatus 1 (also referred to as dedicated signaling or UE specific signaling). The signaling dedicated to the terminal apparatus 1 is also referred to as dedicated RRC signaling. A serving cell-specific higher layer parameter may be transmitted using the signaling common to the multiple terminal apparatuses 1 in the serving cell or the signaling dedicated to a certain terminal apparatus 1. A UE-specific higher layer parameter may be transmitted using signaling dedicated to a certain terminal apparatus 1.

A Broadcast Control CHannel (BCCH), a Common Control CHannel (CCCH), and a Dedicated Control CHannel (DCCH) are logical channels. For example, the BCCH is a higher layer channel used to transmit the MIB. Furthermore, the Common Control CHannel (CCCH) is a higher layer channel used to transmit information common to the multiple terminal apparatuses 1. Here, the CCCH may be used for a terminal apparatus 1 that is not RRC-connected, for example. Moreover, a Dedicated Control CHannel (DCCH) is a higher layer channel used at least to transmit dedicated control information to the terminal apparatus 1. Here, the DCCH may be used for a terminal apparatus 1 that is RRC-connected, for example.

The BCCH in the logical channel may be mapped to the BCH, the DL-SCH, or the UL-SCH in the transport channel The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to the PUSCH in the physical channel. The DL-SCH in the transport channel may be mapped to the PDSCH in the physical channel. The BCH in the transport channel may be mapped to the PBCH in the physical channel

A structural example of the terminal apparatus 1 according to the one aspect of the present embodiment will be described below.

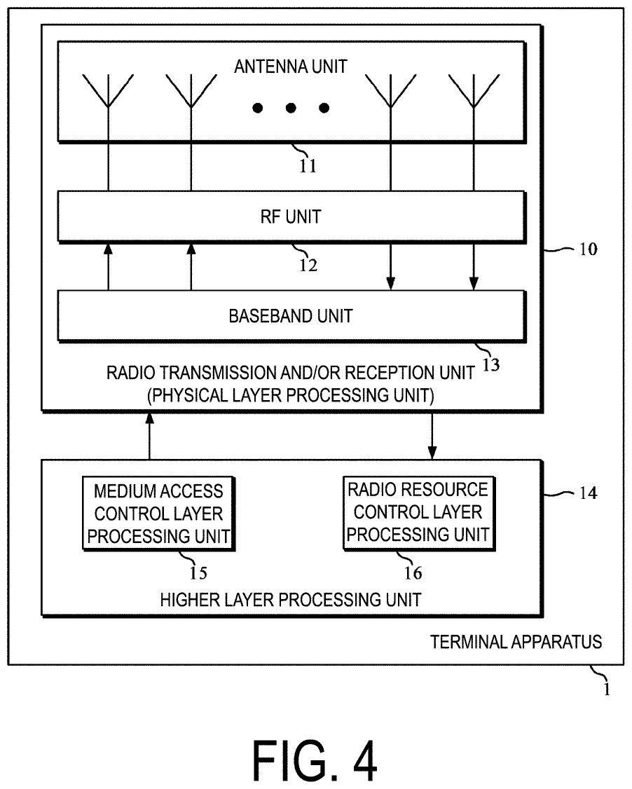

FIG. 4 is a schematic block diagram illustrating a structure of the terminal apparatus 1 according to an aspect of the present embodiment. As illustrated, the terminal apparatus 1 includes a radio transmission and/or reception unit 10 and a higher layer processing unit 14. The radio transmission and/or reception unit 10 includes at least some or all of an antenna unit 11, a Radio Frequency (RF) unit 12, and a baseband unit 13. The higher layer processing unit 14 includes at least some or all of a medium access control layer processing unit 15 and a radio resource control layer processing unit 16. The radio transmission and/or reception unit 10 is also referred to as a transmitter, a receiver, or a physical layer processing unit.

The higher layer processing unit 14 outputs uplink data (transport block) generated by a user operation or the like to the radio transmission and/or reception unit 10. The higher layer processing unit 14 performs processing of an MAC layer, a Packet Data Convergence Protocol (PDCP) layer, a Radio Link Control (RLC) layer, and an RRC layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 manages various types of configuration information/parameters of the terminal apparatus 1. The radio resource control layer processing unit 16 sets various types of configuration information/parameters based on a higher layer signaling received from the base station apparatus 3. In other words, the radio resource control layer processing unit 16 sets the various configuration information/parameters based on the information indicating the various configuration information/parameters received from the base station apparatus 3. Note that the configuration information may include information related to the processing or configurations of the physical channel, the physical signal (that is, the physical layer), the MAC layer, the PDCP layer, the RLC layer, and the RRC layer. The parameters may be higher layer parameters.

The radio transmission and/or reception unit 10 performs processing of the physical layer, such as modulation, demodulation, coding, and decoding. The radio transmission and/or reception unit 10 demultiplexes, demodulates, and decodes a received physical signal and outputs the decoded information to the higher layer processing unit 14. The radio transmission and/or reception unit 10 generates a physical signal by performing modulation and coding of data and generating a baseband signal (conversion into a time-continuous signal) and transmits the physical signal to the base station apparatus 3.

The RF unit 12 converts (down converts) a signal received via the antenna unit 11 into a baseband signal by orthogonal demodulation and removes unnecessary frequency components. The RF unit 12 outputs a processed analog signal to the baseband unit.

The baseband unit 13 converts the analog signal input from the RF unit 12 into a digital signal. The baseband unit 13 removes a portion corresponding to a Cyclic Prefix (CP) from the converted digital signal, performs a Fast Fourier Transform (FFT) on the signal from which the CP has been removed, and extracts a signal in the frequency domain.

The baseband unit 13 generates an OFDM symbol by performing Inverse Fast Fourier Transform (IFFT) on the data, adds CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 through a low-pass filter, up converts the analog signal into a signal of a carrier frequency, and transmits the up converted signal via the antenna unit 11. Also, the RF unit 12 amplifies power. In addition, the RF unit 12 may have a function of controlling transmit power. The RF unit 12 is also referred to as a transmit power controller.

Hereinafter, a structural example of the base station apparatus 3 according to an aspect of the present embodiment will be described below.

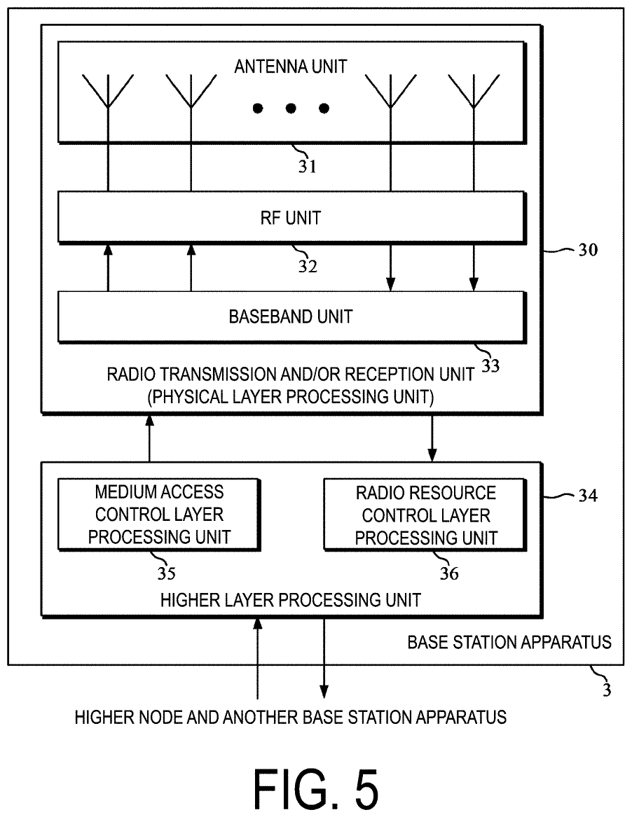

FIG. 5 is a schematic block diagram illustrating a structure of the base station apparatus 3 according to an aspect of the present embodiment. As illustrated, the base station apparatus 3 includes a radio transmission and/or reception unit 30 and a higher layer processing unit 34. The radio transmission and/or reception unit 30 includes an antenna unit 31, an RF unit 32, and a baseband unit 33. The higher layer processing unit 34 includes a medium access control layer processing unit 35 and a radio resource control layer processing unit 36. The radio transmission and/or reception unit 30 is also referred to as a transmitter, a receiver, or a physical layer processing unit.

The higher layer processing unit 34 performs processing of an MAC layer, a PDCP layer, an RLC layer, and an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 generates, or acquires from a higher node, downlink data (transport block) mapped to a PDSCH, system information, an RRC message, an MAC CE, and the like, and outputs the data to the radio transmission and/or reception unit 30. Further, the radio resource control layer processing unit 36 manages various types of configuration information/parameters for each terminal apparatus 1. The radio resource control layer processing unit 36 may set various types of configuration information/parameters for each terminal apparatus 1 via higher layer signals. In other words, the radio resource control layer processing unit 36 transmits/broadcasts information indicating various types of configuration information/parameters. Note that the configuration information may include information related to the processing or configurations of the physical channel, the physical signal (that is, the physical layer), the MAC layer, the PDCP layer, the RLC layer, and the RRC layer. The parameters may be higher layer parameters.

The functionality of the radio transmission and/or reception unit 30 is similar to the functionality of the radio transmission and/or reception unit 10, and description thereof will thus be omitted.

Each of the units having the reference signs 10 to 16 included in the terminal apparatus 1 may be implemented as a circuit. Each of the units having the reference signs 30 to 36 included in the base station apparatus 3 may be implemented as a circuit.

The terminal apparatus 1 may perform Carrier sense prior to transmission of a physical signal. Also, the base station apparatus 3 may perform carrier sense prior to transmission of a physical signal. The carrier sense may be to perform Energy detection on a Radio channel. Whether the physical signal can be transmitted may be provided based on the carrier sense performed prior to transmission of the physical signal. In a case that the amount of energy detected in carrier sense performed prior to transmission of a physical signal is greater than a prescribed threshold value, for example, the transmission of the physical channel may not be performed, or it may be determined that the transmission is not possible. Also, in a case that the amount of energy detected in the carrier sense performed prior to the transmission of the physical signal is smaller than the prescribed threshold value, the transmission of the physical channel may be performed, or it may be determined that the transmission is possible. Moreover, in a case that the amount of energy detected in the carrier sense performed prior to the transmission of the physical signal is equal to the prescribed threshold value, the transmission of the physical channel may be performed or may not be performed. In other words, in a case that the amount of energy detected in the carrier sense performed prior to the transmission of the physical signal is equal to the prescribed threshold value, it may be determined that the transmission is not possible, or it may be determined that the transmission is possible.

A procedure in which whether the transmission of the physical channel is possible based on the carrier sense is also referred to as Listen Before Talk (LBT). A situation in which the transmission of the physical signal is determined to be not possible as a result of the LBT is also referred to as a busy state or busy. For example, the busy state may be a state in which the amount of energy detected in the carrier sense is greater than the prescribed threshold value. In addition, the situation in which the transmission of the physical signal is determined to be possible as a result of the LBT is also referred to as an idle state or idle. For example, the idle state may be a state in which the amount of energy detected in the carrier sense is smaller than the prescribed threshold value.

The terminal apparatus 1 may multiplex uplink control information (UCI) to the PUCCH and transmit the PUCCH. The terminal apparatus 1 may multiplex the UCI to the PUSCH and transmit the PUSCH. The UCI may include at least one of downlink Channel State Information (CSI), a Scheduling Request (SR) indicating a request for a PUSCH resource, and a Hybrid Automatic Repeat request ACKnowledgement (HARQ-ACK) for downlink data (a Transport block, a Medium Access Control Protocol Data Unit (MAC PDU), a Downlink-Shared Channel (DL-SCH), and/or a Physical Downlink Shared Channel (PDSCH)).

The HARQ-ACK may also be referred to as an ACK/NACK, HARQ feedback, HARQ-ACK feedback, a HARQ response, a HARQ-ACK response, HARQ information, HARQ-ACK information, HARQ control information, and HARQ-ACK control information.

In a case that downlink data is successfully decoded, an ACK for the downlink data is generated. In a case that downlink data is not successfully decoded, a NACK for the downlink data is generated. The HARQ-ACK may include at least a HARQ-ACK bit corresponding at least to one transport block. The HARQ-ACK bit may indicate an ACKnowledgement (ACK) or a Negative-ACKnowledgement (NACK) corresponding to one or multiple transport blocks. The HARQ-ACK may include at least a HARQ-ACK codebook including one or multiple HARQ-ACK bits. The fact that the HARQ-ACK bit corresponds to one or multiple transport blocks may mean that the HARQ-ACK bit corresponds to the PDSCH including the one or multiple transport blocks.

HARQ control for one transport block may be referred to as a HARQ process. One HARQ process identifier may be provided for each HARQ process.

The terminal apparatus 1 may report HARQ-ACK information to the base station apparatus 3 by using the HARQ-ACK codebook in the slot indicated by a value of the HARQ indicator field included in DCI format 1_0 or DCI format 1_1 corresponding to PDSCH reception.

For DCI format 1_0, the value of the HARQ indicator field may be mapped to a set of the number of slots (1, 2, 3, 4, 5, 6, 7, 8). For DCI format 1_1, the value of the HARQ indicator field may be mapped to the set of the number of slots provided by a higher layer parameter dl-DataToUL-ACK. The number of slots indicated based at least on the value of the HARQ indicator field may also be referred to as a HARQ-ACK timing or K1. For example, the HARQ-ACK indicating a decoding state of the PDSCH (downlink data) transmitted in the slot n may be reported (transmitted) in the slot n+K1.

dl-DataToUL-ACK indicates a list of timings of the HARQ-ACK for the PDSCH. The timing is the number of slots from the slot in which the HARQ-ACK for the received PDSCH is transmitted, with reference to the slot in which the PDSCH is received (or the slot including the last OFDM symbol to which the PDSCH is mapped). For example, dl-DataToUL-ACK is a list of one, two, three, four, five, six, seven, or eight timings. In a case that dl-DataToUL-ACK is a list of one timing, the HARQ indicator field is 0 bits. In a case that dl-DataToUL-ACK is a list of two timings, the HARQ indicator field is 1 bit. In a case that dl-DataToUL-ACK is a list of three or four timings, the HARQ indicator field is 2 bits. In a case that dl-DataToUL-ACK is a list of five, six, seven, or eight timings, the HARQ indicator field is 3 bits. For example, dl-DataToUL-ACK includes a list of timings of any value in the range from 0 to 31. For example, dl-DataToUL-ACK includes a list of timings of any value in the range from 0 to 63.

The size of dl-DataToUL-ACK is defined as the number of elements included in dl-DataToUL-ACK. The size of dl-DataToUL-ACK may be referred to as Lₚₐᵣₐ. The index of dl-DataToUL-ACK indicates the order (number) of the element of dl-DataToUL-ACK. For example, in a case that the size of dl-DataToUL-ACK is 8 (Lₚₐᵣₐ=8), the index of dl-DataToUL-ACK is any value of 1, 2, 3, 4, 5, 6, 7, or 8. The index of dl-DataToUL-ACK may be provided, may be represented, or may be indicated by a value indicated by the HARQ indicator field.

An example of a configuration of the HARQ indicator field will be described. For example, dl-DataToUL-ACK includes a list of eight timings of 0, 7, 15, 23, 31, 39, 47, and 55, and the HARQ indicator field includes 3 bits. The HARQ indicator field of “000” corresponds to 0 being the first in the list of dl-DataToUL-ACK as a corresponding timing. Specifically, the HARQ indicator field of “000” corresponds to the value 0 indicated by the index 1 of dl-DataToUL-ACK. The HARQ indicator field of “001” corresponds to 7 being the second in the list of dl-DataToUL-ACK as a corresponding timing. The HARQ indicator field of “010” corresponds to 15 being the third in the list of dl-DataToUL-ACK as a corresponding timing. The HARQ indicator field of “011” corresponds to 23 being the fourth in the list of dl-DataToUL-ACK as a corresponding timing. The HARQ indicator field of “100” corresponds to 31 being the fifth in the list of dl-DataToUL-ACK as a corresponding timing. The HARQ indicator field of “101” corresponds to 39 being the sixth in the list of dl-DataToUL-ACK as a corresponding timing. The HARQ indicator field of “110” corresponds to 47 being the seventh in the list of dl-DataToUL-ACK as a corresponding timing. The HARQ indicator field of “111” corresponds to 55 being the eighth in the list of dl-DataToUL-ACK as a corresponding timing. In a case that the received HARQ indicator field indicates “000”, the terminal apparatus 1 transmits a corresponding HARQ-ACK in the 0th slot from the slot of the received PDSCH. In a case that the received HARQ indicator field indicates “001”, the terminal apparatus 1 transmits a corresponding HARQ-ACK in the 7th slot from the slot of the received PDSCH. In a case that the received HARQ indicator field indicates “010”, the terminal apparatus 1 transmits a corresponding HARQ-ACK in the 15th slot from the slot of the received PDSCH. In a case that the received HARQ indicator field indicates “011”, the terminal apparatus 1 transmits a corresponding HARQ-ACK in the 23rd slot from the slot of the received PDSCH. In a case that the received HARQ indicator field indicates “100”, the terminal apparatus 1 transmits a corresponding HARQ-ACK in the 31st slot from the slot of the received PDSCH. In a case that the received HARQ indicator field indicates “101”, the terminal apparatus 1 transmits a corresponding HARQ-ACK in the 39th slot from the slot of the received PDSCH. In a case that the received HARQ indicator field indicates “110”, the terminal apparatus 1 transmits a corresponding HARQ-ACK in the 47th slot from the slot of the received PDSCH. In a case that the received HARQ indicator field indicates “111”, the terminal apparatus 1 transmits a corresponding HARQ-ACK in the 55th slot from the slot of the received PDSCH. The value of the HARQ indicator field may be provided in binary numbers, or may be provided in decimal numbers. For example, the fact that the value of the HARQ indicator field indicates “010” in binary numbers may correspond to the fact that the value of the HARQ indicator field indicates “2” in decimal numbers.

In a case that a higher layer parameter pdsch-AggregationFactor is provided to the terminal apparatus 1, N_{PDSCH}^{repeat} may be a value of the pdsch-AggregationFactor. In a case that the higher layer parameter pdsch-AggregationFactor is not provided to the terminal apparatus 1, N_{PDSCH}^{repeat} may be one. The terminal apparatus 1 may report the HARQ-ACK information for PDSCH reception from the slot n−N_{PDSCH}^{repeat}+1 to the slot n using PUCCH transmission and/or PUSCH transmission in the slot n+k. Here, k may be the number of slots indicated by the HARQ indicator field included in the DCI format corresponding to the PDSCH reception. Further, in a case that the HARQ indicator field is not included in the DCI format, k may be provided by the higher layer parameter dl-DataToUL-ACK.

In a case that the terminal apparatus 1 is configured to monitor the PDCCH including DCI format 1_0 and is configured not to monitor the PDCCH including DCI format 1_1, the HARQ-ACK timing value K1 may be some or all of (1, 2, 3, 4, 5, 6, 7, and 8). In a case that the terminal apparatus 1 is configured to monitor the PDCCH including DCI format 1_1, the HARQ-ACK timing value K1 may be provided by a higher layer parameter dl-DataToUL-ACK.

In a case that the terminal apparatus 1 is configured to monitor the PDCCH including DCI format 1_1, the HARQ-ACK timing value K1 may be provided based at least on a combination of the HARQ indicator field (first field) included in the DCI format 1_1 and a second field other than the field. The second field may be hereinafter referred to as a HARQ auxiliary indicator field.

In a case that the terminal apparatus 1 is configured to monitor the PDCCH including DCI format 1_1, the HARQ-ACK timing value K1 may be provided based at least on a combination of the HARQ indicator field and a prescribed element. The prescribed element may at least include some or all of the CCE index of the PDCCH, the index of the control resource set of the PDCCH, the index of the search space set of the PDCCH, the HARQ process identifier of the PDSCH scheduled in the DCI format 1_1, the slot index of the PDSCH, a Slot Format Indicator (SFI) field included in a second DCI format, a value indicated by the PUCCH resource indicator field included in the DCI format 1_1, and the index of the resource block provided for the PDSCH. The prescribed element may be hereinafter referred to as a HARQ auxiliary indication element.

The HARQ indicator field may correspond to one dl-DataToUL-ACK. The HARQ indicator field may correspond to multiple dl-DataToUL-ACKs (that is, a set of dl-DataToUL-ACKs).

In a case that the HARQ indicator field corresponds to one dl-DataToUL-ACK, the HARQ-ACK timing value K1 may be provided by a combination of the HARQ indicator field and the HARQ auxiliary indicator field. For example, the HARQ-ACK timing value K1 may be provided by 2^{NB}·N_{HARQ_assist}+N_{HARQ_value}. N_{HARQ_value} is a value of dl-DataToUL-ACK corresponding to the value indicated by the HARQ indicator field. In a case that the HARQ indicator field corresponds to one dl-DataToUL-ACK, the index of dl-DataToUL-ACK indicating the HARQ-ACK timing value K1 may be provided by a combination of the HARQ indicator field and the HARQ auxiliary indicator field. The index of dl-DataToUL-ACK may be provided by 2^{NB}·N_{HARQ_assist}+N_{HARQ_timing}+1. The index of dl-DataToUL-ACK may be provided by N_{group}·N_{HARQ_timing}+N_{HARQ_assist}+1. NB is the number of bits of the HARQ indicator field. N_{HARQ_timing} is a value indicated by the HARQ indicator field. N_{HARQ_assist} is a value indicated by the HARQ auxiliary indicator field. Lₚₐᵣₐ is the number of elements included in dl-DataToUL-ACK. N_{group} may be provided by ceil(Lₚₐᵣₐ/2^{NB}). The ceil(X) function is a roof function, and is defined as a minimum integer equal to or greater than X for X.

In a case that the HARQ indicator field corresponds to one dl-DataToUL-ACK, the HARQ-ACK timing value K1 may be provided by a combination of the HARQ indicator field and the HARQ auxiliary indication element. For example, the HARQ-ACK timing value K1 may be provided by 2^{NB}·(N_{HARQ_element} mod N_{group}) N_{HARQ_value}. In a case that the HARQ indicator field corresponds to one dl-DataToUL-ACK, the index of dl-DataToUL-ACK indicating the HARQ-ACK timing value K1 may be provided by a combination of the HARQ indicator field and the HARQ auxiliary indication element. The index of dl-DataToUL-ACK may be provided by 2^{NB}·(N_{HARQ_element} mod N_{group})+N_{HARQ_timing}+1. The index of dl-DataToUL-ACK may be provided by ceil(Lₚₐᵣₐ/2^{NB})·N_{HARQ_timing}+(N_{HARQ_element} mod 2^{NB})+1. N_{HARQ_element} is a value indicated by the HARQ auxiliary indication element. Calculation of X mod Y is calculation of dividing X by Y and acquiring a remainder.

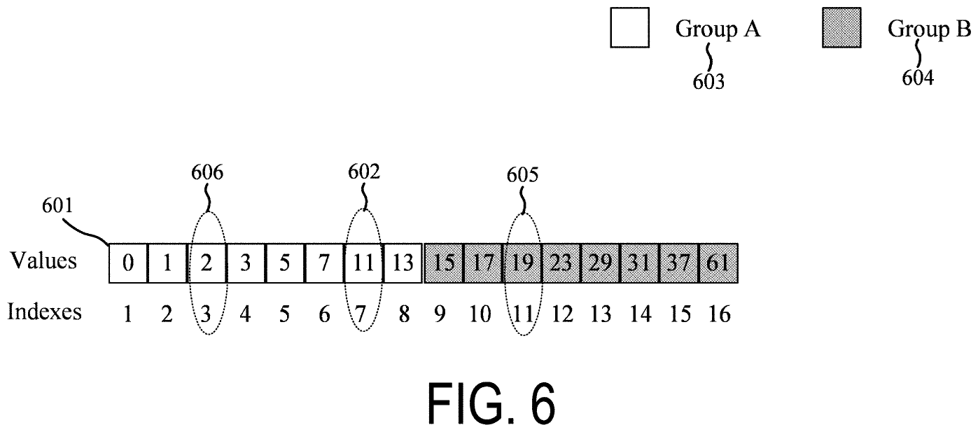

FIG. 6 is a diagram illustrating a method of calculating the index of dl-DataToUL-ACK in a case that the HARQ indicator field corresponds to one dl-DataToUL-ACK according to an aspect of the present embodiment.

In FIG. 6, NB is 3, and dl-DataToUL-ACK is configured as a list 601 of 16 timings of 0, 1, 2, 3, 5, 7, 11, 13, 15, 17, 19, 23, 29, 31, 37, and 61. For example, an index 602 of dl-DataToUL-ACK 601 is indicated at timing 11. In a case that the HARQ auxiliary indicator field is used and the index of dl-DataToUL-ACK is provided by 2^{NB}·N_{HARQ_assist}+N_{HARQ_timing}+1, N_{HARQ_assist}=0 corresponds to a Group A 603, and N_{HARQ_assist}=1 corresponds to a Group B 604. As a specific example, in a case that N_{HARQ_assist}=1 and N_{HARQ_timing}=3 are set, the index of dl-DataToUL-ACK is 8·1+3=11, and timing indicated by an index 605 is 19. Based on a timing value 19 corresponding to an index 11 of dl-DataToUL-ACK, the terminal apparatus 1 may perform HARQ-ACK feedback corresponding to the PDSCH in a slot n+19 after the slot n in which the terminal apparatus 1 receives the PDSCH.

In FIG. 6, in a case that the HARQ auxiliary indication element is used and the index of dl-DataToUL-ACK is provided by 2^{NB}·(N_{HARQ_element} mod N_{group}) N_{HARQ_timing}+1, by N_{HARQ_element}, it corresponds to any group of the Group A 603 and the Group B 604. Here, N_{group}=ceil(16/8)=2. For example, in a case that N_{HARQ_element}=3, N_{HARQ_element} mod N_{group}=1, and it corresponds to the Group B 604. For example, in a case that N_{HARQ_element}=6, N_{HARQ_element} mod N_{group}=0, and it corresponds to the Group A 603. As a specific example, in a case that N_{HARQ_element}=6 and N_{HARQ_timing}=3 are set, the index of dl-DataToUL-ACK is 8·(6 mod 2)+3=8·0+3=3, and timing indicated by an index 606 is 2. Based on a timing value 2 corresponding to an index 3 of dl-DataToUL-ACK, the terminal apparatus 1 may perform HARQ-ACK feedback corresponding to the PDSCH in a slot n+2 after the slot n in which the terminal apparatus 1 receives the PDSCH.

Multiple dl-DataToUL-ACKs may be indicated for the terminal apparatus 1 from the base station apparatus 3. For example, two (set) dl-DataToUL-ACKs (dl-DataToUL-ACK 0 and dl-DataToUL-ACK 1) are indicated. For example, dl-DataToUL-ACK 0 includes a list of eight timings of 0, 1, 2, 3, 4, 5, 6. and 7, and dl-DataToUL-ACK 1 includes a list of eight timings of 8, 9, 10, 11, 12, 13, 14, and 15.

In a case that the HARQ indicator field corresponds to multiple dl-DataToUL-ACKs, the HARQ-ACK timing value K1 may be provided based at least on a combination of the HARQ indicator field and the HARQ auxiliary indicator field. The base station apparatus 3 indicates or notifies of dl-DataToUL-ACK associated with the HARQ indicator field included in the DCI format to the terminal apparatus 1 by using the HARQ auxiliary indicator field. For example, one dl-DataToUL-ACK associated with the HARQ indicator field may be provided, may be represented, or may be indicated by the HARQ auxiliary indicator field. In a case that the HARQ indicator field corresponds to multiple dl-DataToUL-ACKs, the HARQ-ACK timing value K1 may be provided based at least on a combination of the HARQ indicator field and the HARQ auxiliary indication element. For example, one dl-DataToUL-ACK associated with the HARQ indicator field may be provided, may be represented, may be indicated, or may be associated by the HARQ auxiliary indication element. The terminal apparatus 1 may report (transmit) one HARQ codebook corresponding to multiple dl-DataToUL-ACKs. The terminal apparatus 1 may report (transmit) HARQ codebooks different from each other that correspond to different dl-DataToUL-ACKs. The different HARQ codebooks may be transmitted on PUCCHs different from each other. As the different PUCCHs, resources being adjacent in the frequency domain may be used. The base station apparatus 3 may notifies the terminal apparatus 1 of resources of the PUCCH for transmission of each HARQ-ACK codebook by using the PUCCH resource indicator field.

The terminal apparatus 1 recognizes dl-DataToUL-ACK associated with the HARQ indicator field included in the received DCI format, based on the HARQ auxiliary indication element. The base station apparatus 3 indicates or notifies of dl-DataToUL-ACK associated with the HARQ indicator field included in the DCI format to the terminal apparatus 1 by using the HARQ auxiliary indication element. For example, the terminal apparatus 1 recognizes dl-DataToUL-ACK associated with the HARQ indicator field included in the received DCI format, based on the CCE index of the PDCCH including the received DCI format. For example, in a case that the remainder obtained by dividing the CCE index by the number of configured dl-DataToUL-ACKs is 0, it is recognized that the HARQ indicator field corresponds to dl-DataToUL-ACK 0. For example, in a case that the remainder obtained by dividing the CCE index by the number of configured dl-DataToUL-ACKs is 1, it is recognized that the HARQ indicator field corresponds to dl-DataToUL-ACK 1. For example, the CCE index may be the first index constituting the PDCCH. Alternatively, the CCE index may be the last index constituting the PDCCH.

For example, the terminal apparatus 1 recognizes dl-DataToUL-ACK associated with the HARQ indicator field included in the received DCI format, based on the index of the control resource set of the PDCCH including the received DCI format. For example, in a case that the remainder obtained by dividing the index of the control resource set by the number of configured dl-DataToUL-ACKs is 0, it is recognized that the index of the control resource set corresponds to dl-DataToUL-ACK 0. For example, in a case that the remainder obtained by dividing the index of the control resource set by the number of configured dl-DataToUL-ACKs is 1, it is recognized that the index of the control resource set corresponds to dl-DataToUL-ACK 1.

For example, the terminal apparatus 1 recognizes dl-DataToUL-ACK associated with the HARQ indicator field included in the received DCI format, based on the index of the search space set (the index of the search space) of the PDCCH including the received DCI format. For example, in a case that the remainder obtained by dividing the index of the search space set by the number of configured dl-DataToUL-ACKs is 0, it is recognized that the HARQ indicator field corresponds to dl-DataToUL-ACK 0. For example, in a case that the remainder obtained by dividing the index of the search space set by the number of configured dl-DataToUL-ACKs is 1, it is recognized that the HARQ indicator field corresponds to dl-DataToUL-ACK 1.

For example, the terminal apparatus 1 recognizes dl-DataToUL-ACK associated with the HARQ indicator field included in the received DCI format, based on the value of the HARQ process identifier of the PDSCH scheduled in the received DCI format. For example, in a case that the remainder obtained by dividing the value of the HARQ process identifier by the number of configured dl-DataToUL-ACKs is 0, it is recognized that the HARQ indicator field corresponds to dl-DataToUL-ACK 0. For example, in a case that the remainder obtained by dividing the value of the HARQ process identifier by the number of configured dl-DataToUL-ACKs is 1, it is recognized that the HARQ indicator field corresponds to dl-DataToUL-ACK 1.

For example, the terminal apparatus 1 recognizes dl-DataToUL-ACK associated with the HARQ indicator field included in the received DCI format, based on the slot index of the PDSCH scheduled in the received DCI format. For example, in a case that the remainder obtained by dividing the slot index of the PDSCH by the number of configured dl-DataToUL-ACKs is 0, it is recognized that the HARQ indicator field corresponds to dl-DataToUL-ACK 0. For example, in a case that the remainder obtained by dividing the slot index of the PDSCH by the number of configured dl-DataToUL-ACKs is 1, it is recognized that the HARQ indicator field corresponds to dl-DataToUL-ACK 1.

For example, the terminal apparatus 1 recognizes dl-DataToUL-ACK associated with the HARQ indicator field included in the received DCI format, based on the value indicated by the Slot Format Indicator (SFI) field included in the second DCI format. For example, in a case that the remainder obtained by dividing the index of the slot in consideration of the value indicated by the slot format indicator field by the number of configured dl-DataToUL-ACKs is 0, it is recognized that the HARQ indicator field corresponds to dl-DataToUL-ACK 0. For example, in a case that the remainder obtained by dividing the index of the slot in consideration of the value indicated by the slot format indicator field by the number of configured dl-DataToUL-ACKs is 1, it is recognized that the HARQ indicator field corresponds to dl-DataToUL-ACK 1.

For example, the terminal apparatus 1 recognizes dl-DataToUL-ACK associated with the HARQ indicator field included in the received DCI format, based on the value indicated by the PUCCH resource indicator field included in the received DCI format. For example, in a case that the remainder obtained by dividing the value indicated by the PUCCH resource indicator field by the number of configured dl-DataToUL-ACKs is 0, it is recognized that the HARQ indicator field corresponds to dl-DataToUL-ACK 0. For example, in a case that the remainder obtained by dividing the value indicated by the PUCCH resource indicator field by the number of configured dl-DataToUL-ACKs is 1, it is recognized that the HARQ indicator field corresponds to dl-DataToUL-ACK 1.

For example, the terminal apparatus 1 recognizes dl-DataToUL-ACK associated with the HARQ indicator field included in the received DCI format, based on the index of the resource block provided for the PDSCH scheduled in the received DCI format. For example, in a case that the remainder obtained by dividing the slot index of the PDSCH by the number of configured dl-DataToUL-ACKs is 0, it is recognized that the HARQ indicator field corresponds to dl-DataToUL-ACK 0. For example, in a case that the remainder obtained by dividing the slot index of the PDSCH by the number of configured dl-DataToUL-ACKs is 1, it is recognized that the HARQ indicator field corresponds to dl-DataToUL-ACK 1. For example, the index of the resource block may be the first index out of the resource blocks allocated to the PDSCH. Further, the index of the resource block may be the last index allocated to the PDSCH.

The terminal apparatus 1 may transmit multiple HARQ-ACKs corresponding to multiple dl-DataToUL-ACKs with one HARQ-ACK codebook. The terminal apparatus 1 may transmit multiple HARQ-ACKs corresponding to respective dl-DataToUL-ACKs with HARQ-ACK codebooks different from each other. For example, in a case that the terminal apparatus 1 detects a prescribed element indicating dl-DataToUL-ACK 0 and a prescribed element indicating dl-DataToUL-ACK 1 within a range of certain multiple slots, the terminal apparatus 1 may generate and transmit two (set) HARQ-ACK codebooks. For example, in a case that the terminal apparatus 1 detects only a prescribed element indicating the prescribed element indicating dl-DataToUL-ACK 0 within a range of certain multiple slots, the terminal apparatus 1 may generate and transmit one (set) HARQ-ACK codebook. For example, in a case that the terminal apparatus 1 detects only a prescribed element indicating the prescribed element indicating dl-DataToUL-ACK 1 within a range of certain multiple slots, the terminal apparatus 1 may generate and transmit one (set) HARQ-ACK codebook. In this manner, by dynamically controlling the number of HARQ-ACK codebooks to be transmitted, reduction of resources necessary for transmission of the PUCCH, avoidance of deterioration of received quality of the PUCCH, or avoidance of increase of transmit power of the PUCCH can be implemented.

The terminal apparatus 1 may transmit multiple HARQ-ACK codebooks on one PUCCH. The terminal apparatus 1 may transmit multiple HARQ-ACK codebooks on PUCCHs different from each other. For example, the terminal apparatus 1 may transmit the HARQ-ACK codebook corresponding to dl-DataToUL-ACK 0 on PUCCH 0, and transmit the HARQ-ACK codebook corresponding to dl-DataToUL-ACK 1 on PUCCH 1. Here, PUCCH 0 and PUCCH 1 include different resources (frequency resources, time resources, code resources, or a combination thereof). In this manner, by performing transmission on different PUCCHs for each of the HARQ-ACK codebooks, mismatch, which may be caused in a case that the terminal apparatus 1 does not detect the PDCCH and does not transmit the HARQ-ACK codebook corresponding to certain dl-DataToUL-ACK, can be resolved. The base station apparatus 3 transmits a signal so as to cause the terminal apparatus 1 to transmit the HARQ-ACK codebook corresponding to dl-DataToUL-ACK 0, and transmits a signal so as to cause the terminal apparatus 1 to transmit the HARQ-ACK codebook corresponding to dl-DataToUL-ACK 1. The base station apparatus 3 performs decoding processing by assuming that the HARQ-ACK codebook corresponding to dl-DataToUL-ACK 0 and the HARQ-ACK codebook corresponding to dl-DataToUL-ACK 1 are included on a certain PUCCH. However, in a case that the terminal apparatus 1 does not detect the PDCCH corresponding to dl-DataToUL-ACK 0 and detects the PDCCH corresponding to dl-DataToUL-ACK 1, the terminal apparatus 1 transmits only the HARQ-ACK codebook corresponding to dl-DataToUL-ACK 1 by including the HARQ-ACK codebook in the PUCCH. In this manner, in a case that there is a mismatch of the HARQ-ACK codebooks transmitted by the base station apparatus 3 and the terminal apparatus 1, there is an error in decoding of the HARQ-ACK codebook in the base station apparatus 3. Each HARQ-ACK codebook is caused to be transmitted on a different PUCCH and the PUCCH transmitted is detected by signal detection in the base station apparatus 3, thus avoiding the mismatch and the error in decoding of the HARQ-ACK codebook.

The resources of the PUCCH used for transmission of each HARQ-ACK codebook are indicated by the DCI format. The resources of multiple PUCCHs are configured for the terminal apparatus 1 by using RRC signaling in advance. Any of the configured resources of the PUCCHs is indicated by the DCI format. As the resources of multiple PUCCHs actually used for transmission, resources being contiguous in the frequency domain or resources with the same frequency domain may be used. In this manner, by allocating the resources, deterioration of Peak to Average Power Ratio (PAPR) characteristics can be reduced.

Various aspects of apparatuses according to an aspect of the present embodiment will be described below.

(1) In order to achieve the aforementioned object, aspects of the present invention provide the following measures. Specifically, the first aspect of the present invention is a terminal apparatus. The terminal apparatus includes: a receiver configured to receive a PDCCH, and receive a PDSCH scheduled based at least on a DCI format included in the PDCCH; and a transmitter configured to report (transmit) HARQ-ACK information corresponding to the PDSCH. A slot for transmitting the HARQ-ACK information is indicated based at least on a combination of a value indicated by a PDSCH-to-HARQ feedback timing indicator field included in the DCI format and a prescribed element. The prescribed element at least includes some or all of an element 1, an element 2, an element 3, an element 4, an element 5, an element 6, an element 7, and an element 8. The element 1 is a CCE index of the PDCCH. The element 2 is an index of a control resource set of the PDCCH. The element 3 is an index of a search space set of the PDCCH. The element 4 is a HARQ process identifier of the PDSCH. The element 5 is a slot index of the PDSCH. The element 6 is a value indicated by a PUCCH resource indicator field included in the DCI format. The element 7 is a value indicated by a Slot Format Indicator (SFI) field included in a second DCI format. The element 8 is an index of a resource block provided for the PDSCH.

(2) The second aspect of the present invention is the terminal apparatus. A higher layer parameter dl-DataToUL-ACK includes a list of timings of transmission of the HARQ-ACK information corresponding to the PDSCH. An index of the higher layer parameter dl-DataToUL-ACK indicating the slot for transmitting the HARQ-ACK information is indicated based at least on a combination of a value indicated by the PDSCH-to-HARQ feedback timing indicator field and the prescribed element.

(3) The third aspect of the present invention is a base station apparatus. The base station apparatus includes: a transmitter configured to transmit a PDCCH, and transmit a PDSCH scheduled based at least on a DCI format included in the PDCCH; and a receiver configured to receive HARQ-ACK information corresponding to the PDSCH. A slot in which a terminal apparatus receiving the PDSCH transmits the HARQ-ACK information is indicated based at least on a combination of a value indicated by a PDSCH-to-HARQ feedback timing indicator field included in the DCI format and a prescribed element. The prescribed element at least includes some or all of an element 1, an element 2, an element 3, an element 4, an element 5, an element 6, an element 7, and an element 8. The element 1 is a CCE index of the PDCCH. The element 2 is an index of a control resource set of the PDCCH. The element 3 is an index of a search space set of the PDCCH. The element 4 is a HARQ process identifier of the PDSCH. The element 5 is a slot index of the PDSCH. The element 6 is a value indicated by a PUCCH resource indicator field included in the DCI format. The element 7 is a value indicated by a Slot Format Indicator (SFI) field included in a second DCI format. The element 8 is an index of a resource block provided for the PDSCH.

(4) The fourth aspect of the present invention is a terminal apparatus. The terminal apparatus includes: a receiver configured to receive a PDCCH, and receive a PDSCH scheduled based at least on a DCI format included in the PDCCH; and a transmitter configured to report (transmit) HARQ-ACK information corresponding to the PDSCH. A slot for transmitting the HARQ-ACK information is indicated based at least on a value indicated by a PDSCH-to-HARQ feedback timing indicator field included in the DCI format and a value indicated by a HARQ auxiliary indicator field.

(5) The fifth aspect of the present invention is a terminal apparatus. The terminal apparatus receives multiple lists by using RRC signalling, each of the multiple lists being a list (dl-DataToUL-ACK) of timings of a PDSCH and a HARQ-ACK, receives a timing indicator (PDSCH-to-HARQ_feedback timing indicator) and a HARQ auxiliary indication indicator (HARQ auxiliary indicator field) by using DCI being used for scheduling of the PDSCH, receives the PDSCH scheduled using the DCI, transmits the HARQ-ACK corresponding to the PDSCH in a slot determined based on a prescribed list out of the multiple lists and a value of the timing indicator, and determines the prescribed list, based on a value of the HARQ auxiliary indication indicator (HARQ auxiliary indicator field).

(6) The sixth aspect of the present invention is a terminal apparatus. The terminal apparatus receives multiple lists by using RRC signalling, each of the multiple lists being a list (dl-DataToUL-ACK) of timings of a PDSCH and a HARQ-ACK, receives a timing indicator (PDSCH-to-HARQ_feedback timing indicator) by using DCI used for scheduling of a PDSCH, receives the PDSCH scheduled using the DCI, transmits the HARQ-ACK corresponding to the PDSCH in a slot determined based on a prescribed list out of the multiple lists and a value of the timing indicator, and determines the prescribed list, based on a HARQ auxiliary indication element (prescribed element). The HARQ auxiliary indication element (prescribed element) is at least any one of a CCE index of a PDCCH including the DCI, a CORESET index of the PDCCH including the DCI, a Search space index of the PDCCH including the DCI, a HARQ process ID of the PDSCH, and an SFI value included in the DCI, or a combination thereof. The terminal apparatus 1 transmits different HARQ-ACKs corresponding to different lists by using HARQ-ACK codebooks different from each other. The terminal apparatus 1 transmits different HARQ-ACK codebooks by using different PUCCHs. The terminal apparatus 1 uses resources being adjacent in the frequency domain as the different PUCCHs.

Each of the program running on a base station apparatus 3 and a terminal apparatus 1 according to the present invention may be a program (a program that causes a computer to function) that controls a Central Processing Unit (CPU) and the like, in such a manner as to implement the functions of the aforementioned embodiment according to the present invention. Also, the information handled in these apparatuses is temporarily loaded into a Random Access Memory (RAM) while being processed, is then stored in a Hard Disk Drive (HDD) and various types of Read Only Memory (ROM) such as a Flash ROM, and is read, modified, and written by the CPU, as necessary.

Note that the terminal apparatus 1 and the base station apparatus 3 according to the aforementioned embodiment may be partially implemented by a computer. In such a case, a program for implementing such control functions may be recorded on a computer-readable recording medium to cause a computer system to read and execute the program recorded on this recording medium.

Note that it is assumed that the “computer system” mentioned here refers to a computer system built into the terminal apparatus 1 or the base station apparatus 3, and the computer system includes an OS and hardware components such as a peripheral device. Furthermore, a “computer-readable recording medium” refers to a portable medium such as a flexible disk, a magneto-optical disk, a ROM, a CD-ROM, and the like, and a storage device such as a hard disk built into the computer system.

Moreover, the “computer-readable recording medium” may include a medium that dynamically retains the program for a short period of time, such as a communication wire that is used to transmit the program over a network such as the Internet or over a communication line such as a telephone line, and a medium that retains the program for a certain period of time, such as a volatile memory within the computer system which functions as a server or a client in a case that the program is transmitted via the communication wire. Furthermore, the aforementioned program may be configured to implement part of the functions described above, and also may be configured to be capable of implementing the functions described above in combination with a program already recorded in the computer system.

The terminal apparatus 1 may include at least one processor, and at least one memory including a computer program instruction (computer program). The memory and the computer program instruction (computer program) may adopt a configuration of causing the terminal apparatus 1 to perform the operation and the processing described in the above embodiment by using a processor. The base station apparatus 3 may include at least one processor, and at least one memory including a computer program instruction (computer program). The memory and the computer program instruction (computer program) may adopt a configuration of causing the base station apparatus 3 to perform the operation and the processing described in the above embodiment by using a processor.

Furthermore, the base station apparatus 3 according to the aforementioned embodiment may be achieved as an aggregation (apparatus group) including multiple apparatuses. Each of the apparatuses included in such an apparatus group may include each function, or some or all portions of each functional block of the base station apparatus 3 according to the aforementioned embodiment. As the apparatus group, it is only necessary to have a complete set of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have some or all of the functions of a higher node for an eNodeB and/or a gNB.

Also, some or all portions of each of the terminal apparatus 1 and the base station apparatus 3 according to the aforementioned embodiment may be implemented as an LSI which is a typical integrated circuit or may be implemented as a chip set. The functional blocks of each of the terminal apparatus 1 and the base station apparatus 3 may be individually implemented as a chip, or some or all of the functional blocks may be integrated into a chip. A circuit integration technique is not limited to the LSI, and may be implemented with a dedicated circuit or a general-purpose processor. Moreover, in a case that with advances in semiconductor technology, a circuit integration technology with which an LSI is replaced appears, it is also possible to use an integrated circuit based on the technology.

In addition, although the aforementioned embodiments have described the terminal apparatus as an example of a communication apparatus, the present invention is not limited to such a terminal apparatus, and is applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope not depart from the gist of the present invention. Furthermore, in the present invention, various modifications are possible within the scope of claims, and embodiments that are made by suitably combining technical means disclosed according to the different embodiments are also included in the technical scope of the present invention. Furthermore, a configuration in which elements described in the respective embodiments and having mutually the same effects, are substituted for one another is also included.

1. A terminal apparatus comprising:
a receiver configured to receive a PDCCH, and receive a PDSCH scheduled based at least on a DCI format included in the PDCCH; and
a transmitter configured to report (transmit) HARQ-ACK information corresponding to the PDSCH, wherein
a slot for transmitting the HARQ-ACK information is indicated based at least on a combination of a value indicated by a PDSCH-to-HARQ feedback timing indicator field included in the DCI format and a prescribed element,
the prescribed element at least includes some or all of an element 1, an element 2, an element 3, an element 4, an element 5, an element 6, an element 7, and an element 8, the element 1 is a CCE index of the PDCCH,
the element 2 is an index of a control resource set of the PDCCH,
the element 3 is an index of a search space set of the PDCCH,
the element 4 is a HARQ process identifier of the PDSCH,
the element 5 is a slot index of the PDSCH,
the element 6 is a value indicated by a PUCCH resource indicator field included in the DCI format,
the element 7 is a value indicated by a Slot Format Indicator (SFI) field included in a second DCI format, and
the element 8 is an index of a resource block provided for the PDSCH.

2. The terminal apparatus according to claim 1, wherein
a higher layer parameter dl-DataToUL-ACK includes a list of timings of transmission of the HARQ-ACK information corresponding to the PDSCH, and
an index of the higher layer parameter dl-DataToUL-ACK indicating the slot for transmitting the HARQ-ACK information is indicated based at least on a combination of a value indicated by the PDSCH-to-HARQ feedback timing indicator field and the prescribed element.

3. A base station apparatus comprising:
a transmitter configured to transmit a PDCCH, and transmit a PDSCH scheduled based at least on a DCI format included in the PDCCH; and
a receiver configured to receive HARQ-ACK information corresponding to the PDSCH, wherein
a slot in which a terminal apparatus receiving the PDSCH transmits the HARQ-ACK information is indicated based at least on a combination of a value indicated by a PDSCH-to-HARQ feedback timing indicator field included in the DCI format and a prescribed element,
the prescribed element at least includes some or all of an element 1, an element 2, an element 3, an element 4, an element 5, an element 6, an element 7, and an element 8,
the element 1 is a CCE index of the PDCCH,
the element 2 is an index of a control resource set of the PDCCH,
the element 3 is an index of a search space set of the PDCCH,
the element 4 is a HARQ process identifier of the PDSCH,
the element 5 is a slot index of the PDSCH,
the element 6 is a value indicated by a PUCCH resource indicator field included in the DCI format,
the element 7 is a value indicated by a Slot Format Indicator (SFI) field included in a second DCI format, and
the element 8 is an index of a resource block provided for the PDSCH.

4. A communication method used for a terminal apparatus, the communication method comprising:
receiving a PDCCH, and receiving a PDSCH scheduled based at least on a DCI format included in the PDCCH; and
reporting (transmitting) HARQ-ACK information corresponding to the PDSCH, wherein a slot for transmitting the HARQ-ACK information is indicated based at least on a combination of a value indicated by a PDSCH-to-HARQ feedback timing indicator field included in the DCI format and a prescribed element,
the prescribed element at least includes some or all of an element 1, an element 2, an element 3, an element 4, an element 5, an element 6, an element 7, and an element 8,
the element 1 is a CCE index of the PDCCH,
the element 2 is an index of a control resource set of the PDCCH,
the element 3 is an index of a search space set of the PDCCH,
the element 4 is a HARQ process identifier of the PDSCH,
the element 5 is a slot index of the PDSCH,
the element 6 is a value indicated by a PUCCH resource indicator field included in the DCI format,
the element 7 is a value indicated by a Slot Format Indicator (SFI) field included in a second DCI format, and
the element 8 is an index of a resource block provided for the PDSCH.

5. A communication method used for a base station apparatus, the communication method comprising:
transmitting a PDCCH, and transmitting a PDSCH scheduled based at least on a DCI format included in the PDCCH; and
receiving HARQ-ACK information corresponding to the PDSCH, wherein
a slot in which a terminal apparatus receiving the PDSCH transmits the HARQ-ACK information is indicated based at least on a combination of a value indicated by a PDSCH-to-HARQ feedback timing indicator field included in the DCI format and a prescribed element,
the prescribed element at least includes some or all of an element 1, an element 2, an element 3, an element 4, an element 5, an element 6, an element 7, and an element 8,
the element 1 is a CCE index of the PDCCH,
the element 2 is an index of a control resource set of the PDCCH,
the element 3 is an index of a search space set of the PDCCH,
the element 4 is a HARQ process identifier of the PDSCH,
the element 5 is a slot index of the PDSCH,
the element 6 is a value indicated by a PUCCH resource indicator field included in the DCI format,
the element 7 is a value indicated by a Slot Format Indicator (SFI) field included in a second DCI format, and
the element 8 is an index of a resource block provided for the PDSCH.
